(19) United States
(12) Patent Application Publication
(10) Pub. No.: US 2022/0067732 A1
(43) Pub. Date: Mar. 3, 2022

(54) TRANSACTION DATA MANAGEMENT SYSTEM

(71) Applicant: TOSHIBA TEC KABUSHIKI KAISHA, Tokyo (JP)

(72) Inventor: Atsushi SEKIMOTO, Narashino Chiba (JP)

(73) Assignee: TOSHIBA TEC KABUSHIKI KAISHA, Tokyo (JP)

(21) Appl. No.: 17/323,831

(22) Filed: May 18, 2021

(30) Foreign Application Priority Data
Aug. 26, 2020 (JP) 2020-142375

(51) Int. Cl. G06Q 20/40; G06Q 20/20; G06Q 20/38; G06Q 20/42

(52) U.S. Cl. CPC G06Q 20/407; G06Q 20/42; G06Q 20/389; G06Q 20/204

(57) ABSTRACT

A transaction data management system includes a terminal device and a server device, in which the server device includes: a storage unit that stores transaction data of credit card settlement, including at least card information of a credit card used in the credit card settlement; a receiving unit that receives instruction information instructing the transaction data as a correction target among the transaction data stored in the storage unit from the terminal device; and a correcting unit that specifies the transaction data as the correction target from the storage unit and registers cancellation data for canceling transaction of the transaction data generated based on contents of the transaction data as the correction target in the storage unit.

### CROSS-REFERENCE TO RELATED APPLICATION

This application is based upon and claims the benefit of priority from Japanese Patent Application No. 2020-142375, filed on Aug. 26, 2020, the entire contents of which are incorporated herein by reference.

### FIELD

Embodiments described herein relate generally to transaction data management systems.

### BACKGROUND

There are settlement devices of various stores that support credit card settlements using credit cards in addition to settlements with cash. In the credit card settlement, a settlement device transmits transaction data related to settlement including card information related to a credit card to a settlement server that supplies a settlement service.

However, since at least a portion of the above-mentioned transaction data is input by an employee of the store, there is a possibility that a typing error such as input error may occur. On the store side, correcting transaction contents of the transmitted transaction data is not generally permitted.

Therefore, in the store, for example, after the customer leaves the store, by re-inputting again all the items of the transaction data as a correction target and re-registering the transaction category as “cancellation category” for example in the settlement server, the data as the correction target of which registration has been completed are offset. Then, after offsetting the data as the correction target of which registration has been completed, the transaction data of which contents are corrected is newly registered to perform recovery of the typing error. Here, when transmitting the transaction data for cancellation or correction to the settlement server, since the card information is required, a response is performed by printing contents of the card information or writing the contents on paper, or a response is performed by storing the contents separately.

However, there is a problem in terms of security that the card information is retained in the store even after the customer leaves the store. Generating the transaction data for cancellation or correction in the store side is laborious work, and there is room for improvement in terms of convenience, such as a possibility of occurrence of a typing error.

### DESCRIPTION OF THE DRAWINGS

FIG. 1 is a schematic configuration diagram of a transaction data management system according to at least one embodiment;

FIG. 2 is a diagram illustrating an example of a hardware configuration of a store terminal according to at least one embodiment;

FIG. 3 is a diagram illustrating an example of a hardware configuration of a server device according to at least one embodiment;

FIG. 4 is a diagram illustrating an example of a data configuration of a transaction table according to at least one embodiment;

FIG. 5 is a diagram illustrating an example of a functional configuration of a store terminal and a server device according to at least one embodiment;

FIG. 6 is a diagram illustrating an example of a correction receiving screen displayed by a display processing unit of at least one embodiment;

FIG. 7 is a diagram illustrating an example of cancellation data generated by a correction processing unit of at least one embodiment;

FIG. 8 is a diagram illustrating an example of the cancellation data generated by the correction processing unit;

FIG. 9 is a diagram illustrating an example of an editing screen displayed by the display processing unit;

FIG. 10 is a diagram illustrating an example of the cancellation data generated by the correction processing unit;

FIG. 11 is a diagram illustrating an example of transaction data generated by the correction processing unit;

FIG. 12 is a diagram illustrating an example of an operation sequence performed by the store terminal and the server device; and

FIG. 13 is a flowchart illustrating an example of a correction process performed by the correction processing unit.

### DETAILED DESCRIPTION

Embodiments provide a transaction data management system capable of safely and easily correcting transaction data of which credit cart settlement has been completed.

According to at least one embodiment, there is provided a transaction data management system of the at least one embodiment including a terminal device and a server device, and the server device includes a storage unit (storage), a receiving unit (receiver), and a correcting unit (at least one processor). The storage unit stores transaction data of credit card settlement, including at least card information of a credit card used in the credit card settlement. The receiving unit receives instruction information instructing the transaction data as a correction target among the transaction data stored in the storage unit from the terminal device. The correcting unit specifies the transaction data as the correction target from the storage unit and registers cancellation data for canceling transaction of the transaction data generated based on contents of the transaction data as the correction target in the storage unit.

Hereinafter, a transaction data management system according to at least one embodiment will be described with reference to the drawings. It is noted that the invention is not limited to the embodiments described below.

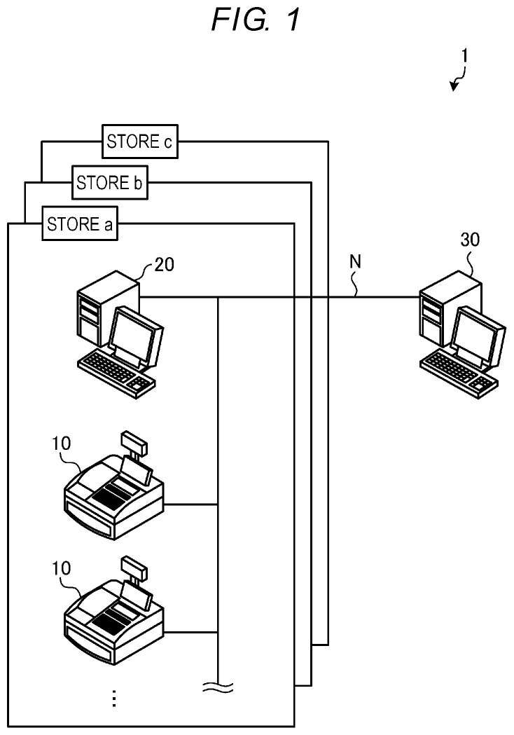

FIG. 1 is a schematic configuration diagram of the transaction data management system according to at least one embodiment. As illustrated in FIG. 1, the transaction data management system 1 includes a POS terminal 10, a store terminal 20, and a server device 30.

The POS terminal 10 and the store terminal 20 are provided in each of the stores (stores a to c) and are connected to the server device 30 via a network N such as a local area network (LAN), a wide area network (WAN), or a dedicated line.

The POS terminal 10 may be provided in a store that supplies merchandises and services (hereinafter, collectively referred to as merchandises). It is noted that, although FIG. 1 illustrates an example in which a plurality of the POS terminals 10 are provided in each store, the number of POS terminals 10 is not particularly limited.

The POS terminal 10 is a sales data processing device that generates sales data of merchandises and registers sales. In addition to cash settlement, the POS terminal 10 can perform settlement (hereinafter, also referred to as credit card settlement) using a credit card. At the time of the credit card settlement, the POS terminal 10 generates transaction data described later including card information such as a card number and expiration date and transmits the transaction data to the settlement server 6.

The store terminal 20 is an example of a terminal device. The store terminal 20 is provided, for example, in the backyard of each store and performs sales management, inventory management, expense management, for example, of the store. When the store terminal 20 corrects the transaction data of the credit card settlement performed by the POS terminal 10, the store terminal 20 performs a process for correcting the transaction data by cooperating with the server device 30.

The server device 30 is an example of the server device. The server device 30 is provided in, for example, a credit card company, for example, and determines whether settlement is possible based on the transaction data transmitted from each store (POS terminal 10). The server device 30 responds with the determination result of whether the settlement is possible to the store (POS terminal 10) that has transmitted the transaction data. When the server device 30 determines that the settlement is possible, the server device 30 registers the transaction data transmitted from the POS terminal 10 in a transaction table 351 (refer to FIG. 3) described later.

In the transaction data management system 1 having the above configuration, when the POS terminal 10 receives the response that the settlement is possible from the server device 30, the POS terminal 10 prints and issues a receipt illustrating the transaction data, and completes the transaction as a state where the settlement has been completed. When the POS terminal 10 receives the response that the settlement is not possible, the POS terminal 10 notifies the fact to the display.

However, in some cases, when inputting transaction data, the operator of the POS terminal 10 may input erroneous information due to reasons such as a typing error. For example, since the operator inputs the items of payment category, business category, for example, which will be described later, there is a possibility that an input error may occur.

In some cases, when the input error cannot be corrected immediately, the operator may inform the customer that the settlement process will be corrected later and hand a temporary slip to the customer. In some cases, after the customer leaves the store, the input error may be recognized.

However, the transaction data once registered on the server is generally not allowed to be deleted or amended from the store side. Therefore, in the related art, the operator performs an operation of offsetting the transaction as an amendment target by generating and transmitting the same data as the registered transaction data as a “cancellation category”. When the item is corrected, the operator performs the operation of substantially correcting the settlement contents of the original transaction by registering the transaction data reflecting the corrected contents as the “sales category”. When generating the transaction data for cancellation or correction, since the card information is required, the operator performs response by printing the contents of the card information or writing the contents on paper or performs response by storing the contents separately.

However, there is a problem of security that the card information is retained in the store even after the customer leaves the store. Generating the transaction data for cancellation or correction by the operator is a laborious work, and there is room for improvement in terms of convenience, such as a possibility of occurrence of a typing error.

Therefore, in the transaction data management system 1 according to the present embodiment, it is possible to safely and easily correct the transaction data of which credit cart settlement has been completed by cooperating the store terminal 20 and the server device 30. Hereinafter, the configurations of the store terminal 20 and the server device 30 described above will be described.

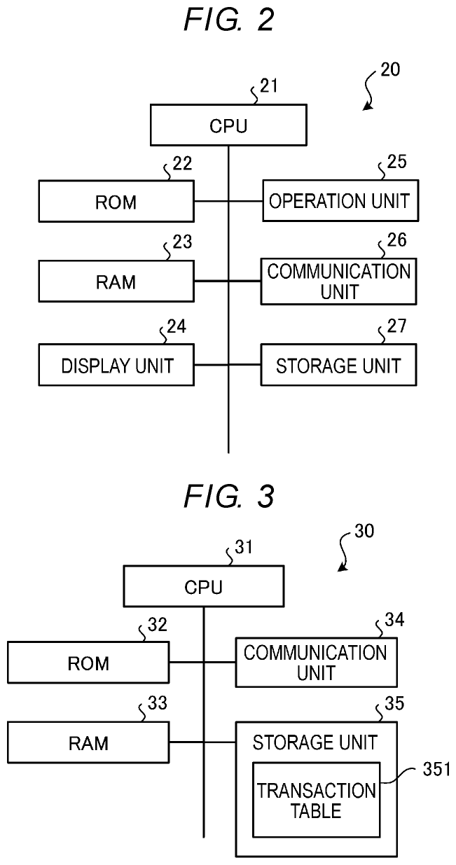

FIG. 2 is a diagram illustrating an example of a hardware configuration of the store terminal 20. As illustrated in FIG. 2, the store terminal 20 has a computer configuration of a central processing unit (CPU) 21, a read only memory (ROM) 22, a random access memory (RAM) 23, for example.

The CPU 21 is an example of a processor and collectively controls each component of the store terminal 20. The ROM 22 stores various programs. The RAM 23 is a workspace on which programs and various data are loaded. The CPU 21 executes various processes by operating according to a program stored in the ROM 22 or a storage unit 27 described later and loaded on the RAM 23.

The store terminal 20 includes a display unit 24 (display controller and display), an operation unit 25, a communication unit 26, a storage unit 27, for example.

The display unit 24 is a display device such as an LCD and displays various information and screens under the control of the CPU 21. The operation unit 25 has various operation keys and outputs operation contents in response to operations of a user to the CPU 21. It is noted that the operation unit 25 may be a touch panel provided on a surface of the display unit 24.

The communication unit 26 is a communication interface that can be connected to the network N. The communication unit 26 communicates with an external device such as the POS terminal 10 or the server device 30 via the network N.

The storage unit 27 is configured with an HDD, a flash memory, or the like, and maintains the stored contents even when power is cut off. The storage unit 27 may store programs and various setting information that can be executed by the CPU 21.

FIG. 3 is a diagram illustrating an example of a hardware configuration of the server device 30. As illustrated in FIG. 3, the server device 30 includes a computer configuration of a CPU 31, a ROM 32, a RAM 33, and the like.

The CPU 31 is an example of a processor and collectively controls each component of the server device 30. The ROM 32 stores various programs. The RAM 33 is a workspace on which programs and various data are loaded. The CPU 31 executes various processes by operating according to the program stored in the ROM 32 or a storage unit 35 described later and loaded on the RAM 33.

The server device 30 includes a communication unit 34, a storage unit 35 (storage), for example. The communication unit 34 is a communication interface that can be connected to the network N. The communication unit 34 communicates with the external device such as the POS terminal 10 or the store terminal 20 via the network N.

The storage unit 35 is configured with an HDD, a flash memory, for example and maintains the stored contents even when power is cut off. The storage unit 35 stores programs and various setting information that can be executed by the CPU 31.

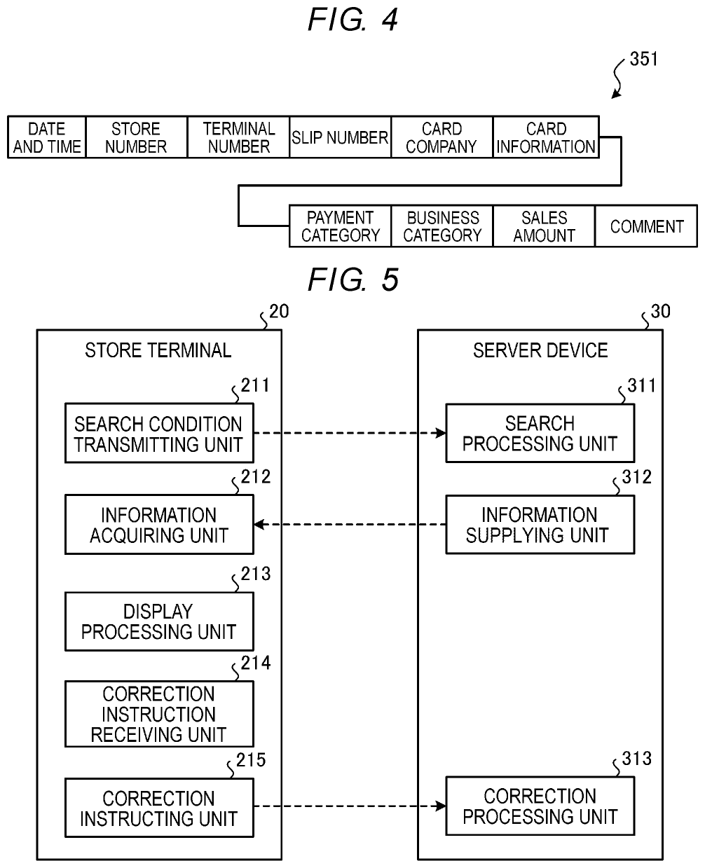

The storage unit 35 stores the transaction table 351 for storing (registering) the transaction data transmitted from the POS terminal 10. Herein, the transaction table 351 is an example of a storage unit. Hereinafter, the data configuration of the transaction table 351 will be described with reference to FIG. 4.

FIG. 4 is a diagram illustrating an example of the data configuration of the transaction table 351. As illustrated in FIG. 4, the transaction table 351 has items of date and time, store number, terminal number, slip number, card company, card information, payment category, business category, sales amount, comment, for example. That is, the transaction data generated by the POS terminal 10 includes the information related to each item of FIG. 4.

Herein, the date denotes the date and time when the transaction (credit card settlement) has been performed. The store number is identification information (identification number) that can identify the store where the transaction has been performed. The terminal number is identification information (identification number) that can identify the POS terminal 10 that has performed the transaction. The slip number is unique identification information (identification number) issued for each transaction. The card company is information such as the international brand name of the credit card and the name of the issuing company that issues the credit card. The card information includes the card number, the expiration date, and the like. It is noted that the card information may be in a form of being stored in plain text or may be in a form of being stored in an encrypted state. The card information may be in a form of being associated with information, such as a slip number, with which the transaction can be specified and retaining the card information in a more secure storage area different from the transaction table 351.

The payment category is information for identifying a payment method such as “lump sum”, “split”, or “bonus payment”, for example. The business category is information indicating the business category of the transaction data such as “sales” and “cancellation”. The sales amount is information indicating the price paid when the customer purchases the merchandise.

The comment is an item to which arbitrary information related to the transaction data can be set. For example, information indicating that the transaction data is “typing error” or a target of “cancellation” can be registered in the comment.

Next, the functional configuration of the store terminal 20 and the server device 30 related to the correction of transaction data will be described with reference to FIG. 5. FIG. 5 is a diagram illustrating an example of the functional configuration of the store terminal 20 and the server device 30. In FIG. 5, in both devices of the store terminal 20 and the server device 30, associated functional units are connected by broken lines.

As illustrated in FIG. 5, the store terminal 20 includes a search condition transmitting unit 211, an information acquiring unit 212, a display processing unit 213, a correction instruction receiving unit 214, and a correction instructing unit 215 as functional units. A portion or all of the functional units included in the store terminal 20 may have a software configuration realized by cooperating the processor (for example, the CPU 21) and the program stored in the memory (for example, the ROM 22 and the storage unit 27) of the store terminal 20. A portion or all of the functional units included in the store terminal 20 may have a hardware configuration realized by a dedicated circuit for example mounted on the store terminal 20.

The server device 30 includes a search processing unit 311, an information supplying unit 312, and a correction processing unit 313 as functional units. A portion or all of the functional units included in the server device 30 may have a software configuration realized by cooperating the processor (for example, the CPU 31 having at least one processor) and the program stored in the memory (for example, the ROM 32, the storage unit 35) of the server device 30. A portion or all of the functional units included in the server device 30 may have a hardware configuration realized by a dedicated circuit for example mounted on the server device 30.

The search condition transmitting unit 211 of the store terminal 20 transmits a search condition for narrowing down the transaction data as a correction target to the server device 30. Specifically, the search condition transmitting unit 211 receives the search condition input from the operator through the operation unit 25. When the search condition transmitting unit 211 receives the input of the search condition, the search condition transmitting unit 211 transmits the search condition to the server device 30.

Herein, the search condition is not particularly limited as long as the search condition relates to the items included in the transaction data. For example, the specific date and time, the store number of the own store, or the like can be used as the search condition. For example, a specific slip number or a specific character string (typing error, or the like) can be used as the search condition.

The search processing unit 311 of the server device 30 is an example of the search unit. When the search processing unit 311 receives the search condition from the store terminal 20, the search processing unit 311 searches for the transaction data corresponding to the search condition from the transaction table 351. For example, when a specific date and time or store number is set to the search condition, the search processing unit 311 searches for the transaction data corresponding to the search condition by referring to the item of the date and time or store number of each transaction data stored in the transaction table 351. For example, when a specific slip number or character string is set to the search condition, the search processing unit 311 searches for the transaction data corresponding to the search condition by referring to the item of the slip number or comment of each transaction data stored in the transaction table 351.

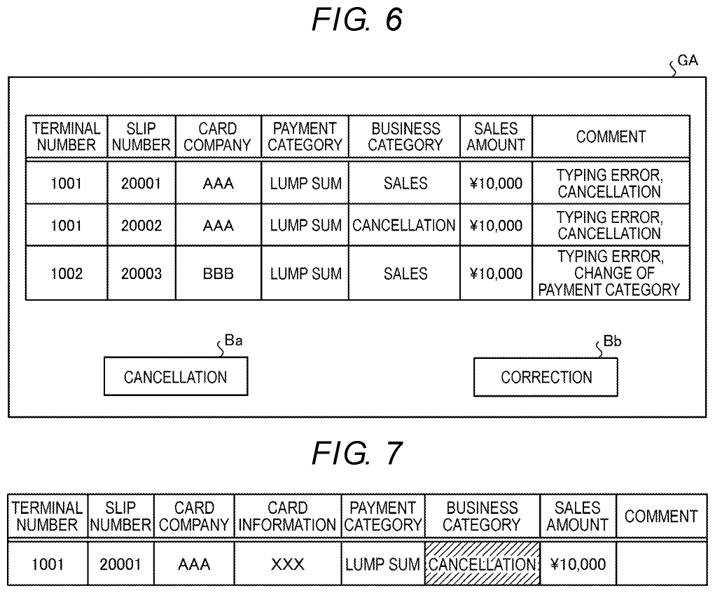

The information supplying unit 312 of the server device 30 is an example of the supplying unit. The information supplying unit 312 supplies a search result of the search processing unit 311 to the store terminal 20 that has transmitted the search condition. Specifically, the information supplying unit 312 reads out the transaction data searched for by the search processing unit 311 from the transaction table 351 and supplies the transaction data as the search result to the store terminal 20. Herein, the information supplying unit 312 supplies the remaining information excluding the card information from the transaction data as the search result to the store terminal 20. The information supplying unit 312 may supply the search result in a form in which the screens according to FIGS. 6 and 9 described later can be displayed.

The information acquiring unit 212 of the store terminal 20 acquires (receives) the information supplied from the information supplying unit 312 of the server device 30. Specifically, the information acquiring unit 212 acquires the search result of the transaction data corresponding to the search condition transmitted by the search condition transmitting unit 211 from the server device 30.

The display processing unit 213 of the store terminal 20 is an example of the display control unit. The display processing unit 213 causes the display unit 24 to display a screen (hereinafter, also referred to as a correction receiving screen) based on the search result acquired by the information acquiring unit 212.

FIG. 6 is a diagram illustrating an example of the correction receiving screen displayed by the display processing unit 213. As illustrated in FIG. 6, the search result transmitted from the server device 30 is displayed on the correction receiving screen GA. FIG. 6 illustrates an example in which the three contents of the transactions of which slip numbers are “20001”, “20002”, and “20003” are displayed as the search result. It is noted that the items of the date and the store number are not displayed.

The correction receiving screen GA is provided with a cancel button Ba and a correct button Bb. The correction instruction receiving unit 214 of the store terminal 20 receives an operation on the correction receiving screen GA through the operation unit 25. It is noted that the correction instruction receiving unit 214 is an example of the operation receiving unit (operation receiver).

Herein, the cancel button Ba is an example of an operator for instructing the cancellation of the transaction. The operator of the store terminal 20 can instruct the cancellation of the transaction by selecting a desired transaction (transaction data) from the search result displayed on the correction receiving screen GA and operating the cancel button Ba.

Specifically, when the correction instruction receiving unit 214 receives the operation of the cancel button Ba, the correction instruction receiving unit 214 outputs the correction instruction information including the slip number of the transaction as a cancellation target and the information (hereinafter, also referred to as cancellation instruction) instructing the cancellation to the correction instructing unit 215.

The correction instructing unit 215 of the store terminal 20 is an example of the correction instructing unit. The correction instructing unit 215 transmits the correction instruction information input from the correction instruction receiving unit 214 to the server device 30. The correction instruction receiving unit 214 may include the current date and time, the store number of the own store, the terminal number of the own device, for example in the correction instruction information.

The correction processing unit 313 of the server device 30 is an example of the receiving unit and the correcting unit. The correction processing unit 313 executes a process for correcting the transaction data registered in the transaction table 351 in response to the correction instruction information transmitted from the store terminal 20.

Specifically, when the correction processing unit 313 receives the correction instruction information including the cancellation instruction from the store terminal 20, the correction processing unit 313 specifies the transaction data corresponding to the transaction number included in the correction instruction information from the transaction table 351. Next, the correction processing unit 313 generates the transaction data (hereinafter, also referred to as cancellation data) offsetting the contents registered in the business category of the transaction data based on the specified transaction data and registers the transaction data in the transaction table 351.

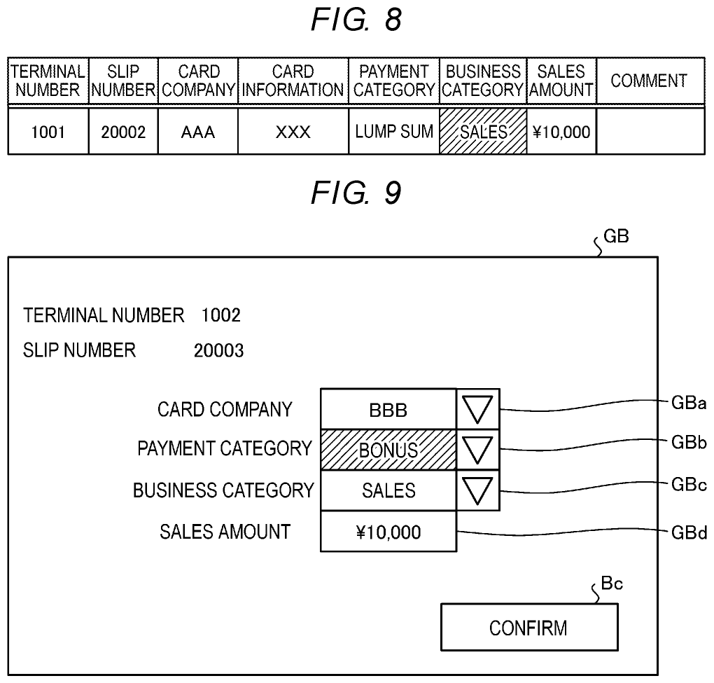

For example, when the cancellation is instructed for the transaction of the slip number “20001” displayed on the correction receiving screen GA of FIG. 6, the correction processing unit 313 generates the cancellation data as illustrated in FIG. 7 and registers the cancellation data in the transaction table 351. For example, when the cancellation is instructed for the transaction of the slip number “20002” displayed on the correction receiving screen GA of FIG. 6, the correction processing unit 313 generates the cancellation data as illustrated in FIG. 8 and registers the cancellation data in the transaction table 351.

Herein, FIGS. 7 and 8 are diagrams illustrating an example of the cancellation data generated by the correction processing unit 313 according to at least one embodiment. In the cancellation data of FIG. 7, the business category “sales” of the transaction data (hereinafter, also referred to as correction original data) of the original slip number “20001” is changed to “cancellation”. In the cancellation data of FIG. 8, the business category “cancellation” of the correction original data of the slip number “20002” is changed to “sales”.

The contents of other items constituting the transaction data are taken over from the item of the correction original data. That is, the server device 30 can perform the process related to the cancellation of the transaction data without transmitting the card information and the transaction contents from the store terminal 20.

As such, when the correction processing unit 313 is instructed to cancel the transaction, the correction processing unit 313 executes the correction process for canceling (denying) the transaction of the correction original data by registering the cancellation data offsetting the contents registered in the business category of the correction original data in the transaction table 351.

Although the date, store number and terminal number are not illustrated in the cancellation data of FIGS. 7 and 8, the cancellation data are assumed to have the same format as the normal transaction data. Here, the items of the date, the store number, and the terminal number may be in a form of taking over the contents of the correction original data, or the contents of each item included in the correction instruction information may be registered. The item of the date and time may be in a form that the correction processing unit 313 registers the current date and time. In the cancellation data of FIGS. 7 and 8, the item of the comment left blank, but the item may be in a form of taking over the contents of the correction original data.

Referring back to FIG. 6, the correct button Bb on the correction receiving screen GA is an operator for instructing the correction (editing) of the transaction contents. The operator of the store terminal 20 can edit the transaction contents of the transaction by selecting a desired transaction (transaction data) from the search result displayed on the correction receiving screen GA and operating the correct button Bb.

Specifically, when the correction instruction receiving unit 214 receives the operation of the correct button Bb, the correction instruction receiving unit 214 allows an editing screen for editing the transaction contents of the transaction as an editing target to be displayed by cooperating with the display processing unit 213.

Herein, FIG. 9 is a diagram illustrating an example of the editing screen displayed by the display processing unit 213. As illustrated in FIG. 9, the terminal number and the slip number of the transaction as the editing target are displayed on the editing screen GB. The editing screen GB is provided with input reception fields GBa to GBd for receiving data amendment for the items that are amendable. In the input reception fields GBa to GBd, the registered contents of the corresponding items read from the transaction as the editing target are initially displayed.

In the input reception fields GBa to GBc, it is possible to select input contents of the corresponding items in a pull-down form. It is possible to input a numerical value (amount) in the input reception field GBd. Accordingly, after confirming the registered contents of the transaction as an editing source, since the operator can input or select the edited contents, it is possible to reduce the input errors. The editable items are not limited to the examples illustrated herein. For example, it is assumed that the item of the card company may be unamendable.

The editing screen GB is provided with a confirm button Bc. The confirm button Bc is an operator for instructing confirmation of the edited contents. The operator of the store terminal 20 can instruct the editing of the transaction by operating any of the input reception fields GBa to GBd, editing the registered contents of the desired item, and, after the editing, operating the confirm button Bc.

Specifically, when the correction instruction receiving unit 214 receives the operation of the confirm button Bc, the correction instruction receiving unit 214 outputs the correction instruction information including the slip number of the transaction as the editing target, the item of the editing target and the registered contents after the editing, and the information (hereinafter, also referred to as an editing instruction) instructing the editing to the correction instructing unit 215. The correction instructing unit 215 transmits the correction instruction information input from the correction instruction receiving unit 214 to the server device 30.

When the correction processing unit 313 of the server device 30 receives the correction instruction information including the editing instruction from the store terminal 20, the correction processing unit 313 specifies the transaction data corresponding to the transaction number included in the correction instruction information from the transaction table 351. Next, the correction processing unit 313 generates the cancellation data offsetting the contents registered in the business category of the transaction data based on the specified transaction data and registers the cancellation data in the transaction table 351. Then, the correction processing unit 313 generates the edited transaction data reflecting the edited registered contents in the item of the editing target based on the specified transaction data and registers the edited transaction data in the transaction table 351.

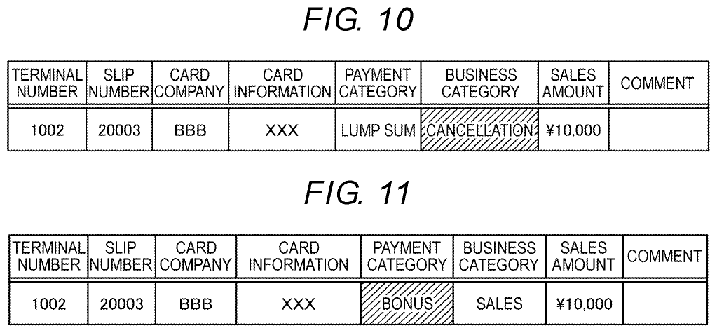

For example, with respect to the transaction with the slip number “20003” displayed on the editing screen GB of FIG. 9, when an editing operation is performed to change the item of the payment category from “lump sum” to “bonus”, the correction processing unit 313 first generates the cancellation data as illustrated in FIG. 10 and registers the cancellation data in the transaction table 351.

Herein, FIG. 10 is a diagram illustrating an example of the cancellation data generated by the correction processing unit 313. Similarly to the above description, in the cancellation data of FIG. 10, the business category “sales” of the correction original data is changed to “cancellation”.

Subsequently, as illustrated in FIG. 11, the correction processing unit 313 generates new transaction data in which the item of the payment category is changed to “bonus” based on the transaction contents of the correction original data of the slip number “20003” and registers the generated new transaction data in the transaction table 351.

FIG. 11 is a diagram illustrating an example of the transaction data generated by the correction processing unit 313 according to at least one embodiment. The transaction data of FIG. 11 reflects the contents of the payment category changed with the editing screen GB of FIG. 9. The contents of other items constituting the transaction data are taken over from the item of the correction original data. That is, the server device 30 can perform the process related to the editing of the transaction data without transmitting the card information and the transaction contents from the store terminal 20.

As such, when the correction processing unit 313 is instructed to edit the transaction content, the correction processing unit 313 performs the correction process for canceling (denying) the transaction of the correction original data, first, by registering the cancellation data offsetting the contents registered in the business category of the correction original data in the transaction table 351. Next, the correction processing unit 313 executes the correction process for replacing the correction original data with the transaction data after editing (after correction) by registering the transaction data with the contents of the item of which editing is instructed being set as the contents after editing based on the contents of the correction original data in the transaction table 351.

Although the date, store number, and terminal number are not illustrated in the cancellation data and transaction data illustrated in FIGS. 10 and 11, the data are assumed to have the same format as the normal transaction data similarly to the above description.

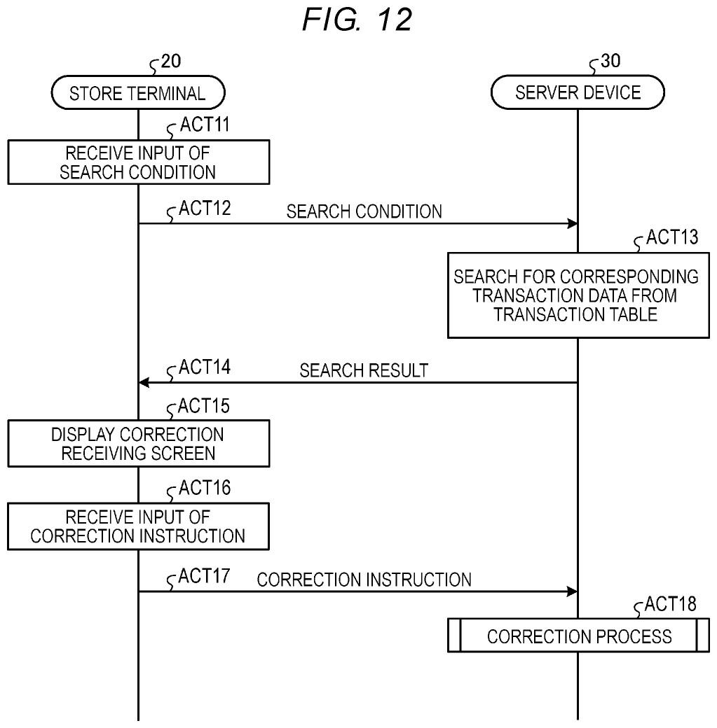

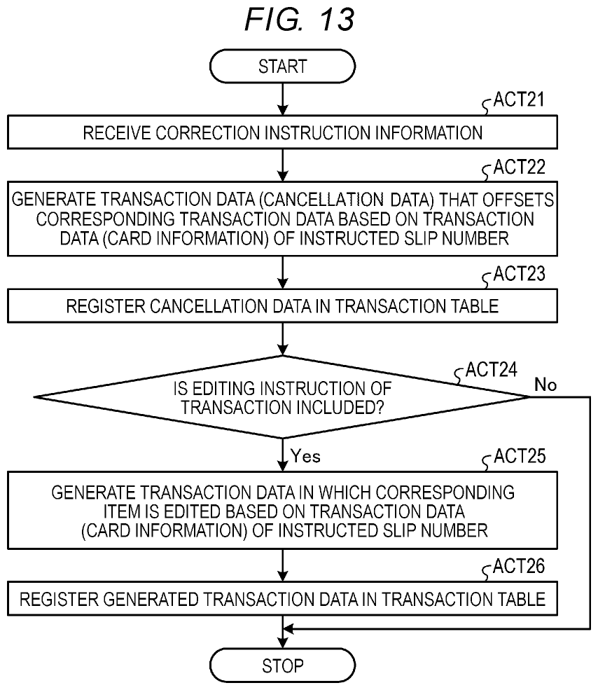

Hereinafter, an operational example of the store terminal 20 and the server device 30 will be described with reference to FIGS. 12 and 13.

First, an operation sequence between the store terminal 20 and the server device 30 related to the correction of transaction data will be described with reference to FIG. 12. Herein, FIG. 12 is a diagram illustrating an example of the operation sequence performed by the store terminal 20 and the server device 30.

First, in the store terminal 20, when the search condition transmitting unit 211 receives the input of the search condition through the operation unit 25 (ACT11), the search condition transmitting unit 211 transmits the received search condition to the server device 30 (ACT12).

On the other hand, in the server device 30, when the search processing unit 311 receives the search condition transmitted from the store terminal 20, the search processing unit 311 searches for the transaction data corresponding to the search condition from the transaction table 351 (ACT13). Next, the information supplying unit 312 of the server device 30 supplies information based on the search result obtained by searching in ACT13 to the store terminal 20 (ACT14). Specifically, the information supplying unit 312 supplies the remaining information obtained by removing at least the card information from the searched transaction data to the store terminal 20 that has transmitted the search condition.

In the store terminal 20, when the information acquiring unit 212 acquires the information supplied by the server device 30, the display processing unit 213 causes the display unit 24 to display the correction receiving screen GA based on the acquired information (ACT15).

Then, when the correction instruction receiving unit 214 receives the input of the correction instruction based on the correction receiving screen GA (or the editing screen GB) (ACT16), the correction instructing unit 215 transmits the correction instruction information indicating the contents of the correction instruction to the server device 30 (ACT17).

When the correction processing unit 313 of the server device 30 receives the correction instruction information from the store terminal 20, the correction processing unit 313 executes the correction process illustrated in FIG. 13 based on the contents instructed by the correction instruction information (ACT18).

FIG. 13 is a flowchart illustrating an example of the correction process performed by the correction processing unit 313 according to at least one embodiment. When the correction processing unit 313 receives the correction instruction information (ACT21), the correction processing unit 313 executes the processes of ACT22 to ACT26 illustrated below.

First, when the correction processing unit 313 specifies the transaction data (correction original data) corresponding to the slip number instructed in the correction instruction information from the transaction table 351, the correction processing unit 313 generates the transaction data (cancellation data) offsetting the contents of the business category of the transaction data (ACT22). It is noted that the cancellation data generated in ACT22 are assumed to inherit the contents of the card information included in the correction original data, as described above.

Subsequently, the correction processing unit 313 registers the cancellation data generated in ACT22 in the transaction table 351 (ACT23).

Subsequently, the correction processing unit 313 determines whether the editing instruction is included in the correction instruction information (ACT24). When it is determined that the editing instruction is not included (ACT24; No), the correction processing unit 313 ends this process.

On the other hand, when it is determined that the editing instruction is included (YES in ACT24), the correction processing unit 313 generates transaction data in which the item of the editing target is edited based on the correction original data (ACT25). As described above, the transaction data generated in ACT25 are assumed to inherit the contents of the card information included in the correction original data.

Then, the correction processing unit 313 registers the transaction data generated in ACT25 in the transaction table 351 (ACT26), and ends this process.

As described above, in the transaction data management system 1, the server device 30 stores the transaction data of the credit card settlement including at least the card information of the credit card used in the credit card settlement in the transaction table 351. When the server device 30 receives the correction instruction information instructing the transaction data as the correction target from the store terminal 20, the server device 30 specifies the corresponding transaction data from the transaction table 351 and registers the cancellation data generated based on the contents of the specified transaction data in the transaction table 351.

Accordingly, in the transaction data management system 1, since the cancellation of the transaction data can be performed without transmitting the card information and the transaction contents from the store terminal 20 to the server device 30, it is possible to safely perform the correction of the transaction data. In the transaction data management system 1, since the server device 30 can perform the cancellation of the transaction data by performing the operation of designating the transaction data as the correction target from the store terminal 20, it is possible to easily perform the correction of the transaction data.

In the server device 30, when the store terminal 20 instructs the edited contents of the transaction data as the correction target, the server device 30 registers the cancellation data, after that, generates new transaction data by editing the transaction data as the correction target in response to the editing content, and registers the new transaction data in the transaction table 351.

Accordingly, in the transaction data management system 1, even when the editing (changing) of the transaction data is instructed, the transaction data reflecting the edited contents can be generated and registered without transmitting the card information or the transaction contents from the store terminal 20. Therefore, in the transaction data management system 1, the correction of the transaction data can be performed safely and easily.

The server device 30 searches for the transaction data corresponding to the search condition from the transaction table 351 based on the search condition transmitted from the store terminal 20 and supplies the transaction data configured with remaining information obtained by removing the card information from each of the searched transaction data as the search result to the store terminal 20. On the other hand, the store terminal 20 causes the display unit 24 to display the transaction data that is a candidate for correction based on the search result supplied by the server device 30, and when the transaction data as the correction target is selected, the store terminal 20 transmits the correction instruction information instructing the transaction data to the server device 30. When the operation instructing editing of the transaction data as the correction target is performed, the store terminal 20 causes the display unit 24 to display the editing screen on which the contents of the transaction data can be edited, and the store terminal 20 transmits the edited contents edited on the editing screen as the correction instruction information to the server device 30.

Accordingly, in the transaction data management system 1, since the transaction data as the correction target can be selected without transferring the card information to the store terminal 20, it is possible to prevent the leakage of the card information, and thus, it is possible to improve security. In the transaction data management system 1, since the operator of the store terminal 20 can perform the operation of canceling or editing the transaction data based on the transaction data displayed on the store terminal 20, it is possible to easily perform the correction of the transaction data.

The above-described at least one embodiment can be appropriately modified and implemented by changing a portion of the configuration or function of each of the above-mentioned devices. Therefore, in the following description, some modified examples according to the above-described embodiments will be described as other embodiments. It is noted that, in the following description, the points different from the above-described embodiments will be mainly described, and detailed description of the points common to the contents already described will be omitted. The modified examples described below may be implemented individually or in combination as appropriate.

### Modified Example 1

In the above-described embodiment, the form of performing the correction of the transaction data by using the store terminal 20 has been described, but the disclosure is not limited thereto, and the form of performing the correction of the transaction data by using another terminal device such as the POS terminal 10 may be employed. Specifically, the terminal device such as the POS terminal 10 is provided with each functional configuration of the store terminal 20 illustrated in FIG. 5, and thus, the correction of the transaction data can be performed similarly to the store terminal 20 of the above-described embodiment.

### Modified Example 2

In the above-described embodiment, the server device 30 supplies the transaction data corresponding to the search condition transmitted from the store terminal 20 to the store terminal 20, but the disclosure is not limited thereto.

For example, the information supplying unit 312 may be in a form of supplying all the transaction data registered in the transaction table 351 to the store terminal 20 or may be in a form of supplying the transaction data including the store number of the store of the store terminal 20 to the store terminal 20. It is noted that the information supplying unit 312 is assumed to supply the transaction data configured with the remaining information obtained by removing the card information from the transaction data to the store terminal in any cases. Accordingly, similarly to the above-described at least one embodiment, it is possible to safely correct the transaction data of which credit cart settlement has been completed.

The program executed by each device of the above-described embodiments is supplied by being incorporated in a ROM or the like in advance. The program executed by each device of the above-described embodiments may be configured to be a file in an installable format or an executable format and to be recorded and supplied on a recording medium such as a CD-ROM, a flexible disk (FD), a CD-R, or a digital versatile disk (DVD) that can be read by a computer.

The program executed by each device of the above-described at least one embodiment may be configured to be stored on a computer connected to a network such as the Internet and supplied by downloading via the network. The program executed by each device of the above-described embodiments may be configured to be supplied or distributed via a network such as the Internet.

While certain embodiments have been described, these embodiments have been presented by way of example only, and are not intended to limit the scope of the disclosure. Indeed, the novel embodiments described herein may be embodied in a variety of other forms: furthermore various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A transaction data management system comprising:
a terminal device; and
a server device, wherein the server device includes:
a storage configured to store transaction data of credit card settlement, including at least card information of a credit card used in the credit card settlement,
a receiver configured to receive instruction information instructing the transaction data as a correction target among the transaction data stored in the storage from the terminal device, and
at least one processor configured to specify the transaction data as the correction target from the storage and to register cancellation data for canceling transaction of the transaction data generated based on contents of the transaction data as the correction target in the storage.

2. The system according to claim 1, wherein the at least one processor is configured to, when the at least one processor is instructed with edited contents of the transaction data as the correction target in the instruction information, register the cancellation data in the storage, and then, generate new transaction data by editing the transaction data as the correction target in response to the edited contents, and register the new transaction data in the storage.

3. The system according to claim 1, wherein the at least one processor is configured to generate the transaction data in which a category of the transaction included in the transaction data as the correction target is changed to a category having an offsetting relationship with the category.

4. The system according to claim 1, wherein
the at least one processor of the server device further is configured to:
a search for the transaction data corresponding to a search condition from the storage based on the search condition transmitted from the terminal device, and
supply the transaction data configured with remaining information obtained by removing the card information from each of the transaction data searched by the at least one processor as a search result corresponding to the search condition to the terminal device, and
the terminal device further includes:
a display,
a display controller configured to cause the display to display the transaction data included in the search result supplied from the server device,
an operation receiver configured to receive selection of the transaction data as the correction target among the transaction data displayed on the display, and
a correction transmitter configured to transmit the instruction information instructing the transaction data as the correction target received by the operation receiver to the server device.

5. The system according to claim 4, wherein
when the operation receiver receives an operation instructing editing of the transaction data as the correction target, the display controller causes the display to display an editing screen on which the contents of the transaction data can be edited, and
the correction transmitter transmits the instruction information instructing the edited contents edited on the editing screen to the server device.

6. The system according to claim 1, wherein the at least one processor is a single processor.

7. The system according to claim 1, wherein the terminal device is a point of sale device.

8. The system according to claim 1, wherein the editing screen includes at least one button arranged to allow contents of the transaction data to be edited.

9. A method of operating a transaction data management system including a terminal device and a server device, the method comprising:
storing, in a storage, transaction data of credit card settlement, including at least card information of a credit card used in the credit card settlement;
receiving instruction information instructing the transaction data as a correction target among the transaction data stored in the storage from the terminal device; and
specifying the transaction data as the correction target from the storage and registering cancellation data for canceling transaction of the transaction data generated based on contents of the transaction data as the correction target in the storage.

10. The method according to claim 9, further comprising:
when the server device is instructed with edited contents of the transaction data as the correction target in the instruction information, registering the cancellation data in the storage, and then, generating new transaction data by editing the transaction data as the correction target in response to the edited contents, and registering the new transaction data in the storage.

11. The method according to claim 9, further comprising generating the transaction data in which a category of the transaction included in the transaction data as the correction target is changed to a category having an offsetting relationship with the category.

12. The method according to claim 9, further comprising:
searching for the transaction data corresponding to a search condition from the storage based on a search condition transmitted from the terminal device;
supplying to the terminal device the transaction data configured with remaining information obtained by removing the card information from each of the transaction data searched by the server as a search result corresponding to the search condition;
causing a display of the terminal device to display the transaction data included in the search result supplied from the server device;
receiving selection of the transaction data as the correction target among the transaction data displayed on the display; and
transmitting to the server device the instruction information instructing the transaction data as the correction target received.

13. The method according to claim 12, wherein
when an operation instructing editing of the transaction data as the correction target is received, the display is caused to display an editing screen on which the contents of the transaction data can be edited, and the instruction information instructing the edited contents edited on the editing screen is transmitted to the server device.
